(19) United States
(12) Patent Application Publication
(10) Pub. No.: US 2008/0059220 A1
(43) Pub. Date: Mar. 6, 2008

(54) BUILDING PLAN COMPLIANCE SYSTEM AND METHOD

(75) Inventors: Kenneth John Roth, Phoenix, AZ (US); Lawrence Leonard Litchfield, Phoenix, AZ (US); Gurupreet Singh Bains, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: PLANCHECK INTERNATIONAL CORPORATION, Phoenix, AZ (US)

(21) Appl. No.: 11/847,577

(22) Filed: Aug. 30, 2007

Related U.S. Application Data
(60) Provisional application No. 60/823,938, filed on Aug. 30, 2006.

(51) Int. Cl. G06Q 99/00

(52) U.S. Cl. 705/1

(57) ABSTRACT

A system for performing a computerized building code compliance check with an appropriate jurisdiction is disclosed. The system enables a user to connect to a compliance utility by way of the Internet in order to upload a CAD file. When a CAD file is received, the system performs an analysis to determine whether the building plan was compiled in accordance with defined naming conventions. When a plan is determined to be of the appropriate format, the system extracts building elements from the CAD file, compares each element against a corresponding jurisdictional code, and determines whether the building plan is compliant. When the system determines that a building plan is compliant, the user is provided with a certificate of compliance. The system further analyzes building plans to provide highly targeted offers and enables vendors to bid to provide goods and services based on plan details.

### CROSS REFERENCE TO RELATED APPLICATIONS

This application claims priority to, and the benefit of, U.S. Provisional Application Ser. No. 60/823,938, filed Aug. 30, 2006 and entitled “System and Method for Automated Evaluation of Plans”, which is hereby incorporated by reference in its entirety.

### FIELD OF INVENTION

The invention generally relates to building plan compliance with local and regional regulations, and more particularly, to a system and method for digitally receiving a building plan, comparing the various elements of the plan with corresponding element restrictions in a compliance database, and reporting any element of the building plan that is not in compliance, along with features related to sourcing and advertising related to the building plan elements.

### BACKGROUND OF THE INVENTION

The process of evaluating building plans for building code compliance is mostly a manual process and a labor intensive process with long turnaround times and backlogs. Building plans are most often submitted to a governing jurisdiction in paper or digital format. The plans are then manually reviewed by trained resources to identify out-of-compliance issues, which are reported back to the designer or builder for correction and re-submittal. This iterative process is typically time-consuming, causing delays in the start of construction and additional costs to the construction project. The existing process is also not conducive to allowing designers to apply a variety of sufficient what-if scenarios to determine more optimal and more cost-effective designs.

Most governmental jurisdictions adopt building ordinances which either include a model code by reference (such as those published by the International Code Council (ICC)), or create their own building code as part of the ordinance. A majority of the jurisdictions adopt the building code by referencing a model code and over 90% of those jurisdictions adopt the ICC codes by reference. When a model code is adopted by a jurisdiction, the code is in the public domain and may be used by all those needing to conduct business with the government entity.

A typical review process includes many cycles of “submit-review-correct-re-review-permit issuance.” Designers are often requested to submit multiple sets of construction drawings (e.g., two sets of each drawing). Both sets are red marked and one set is returned to the designer for correction. The designer is then requested to return two sets of corrected drawings along with an initial redlined set. Plan reviewers follow a basic routine in their review process incorporating manual check lists, as well as developing their own individual techniques. For compliance with the building code, a reviewer initially checks the plans for completeness, and if complete, gathers basic information such as, for example, occupancy and use, type of construction, location on the lot relative to property lines and other buildings, whether fire sprinklers are provided, the number of stories, and other pertinent information that will be included throughout the drawing set. Once the basic information is determined, the reviewer generally makes a determination as to whether the information provided indicates if the proposed design meets the minimum provisions of the code. Typical code provisions include, for example, exiting requirements as a function of the occupancy, height, fire protection, type of exits provided and layout of the exiting system. The reviewer usually compares the proposed design to the minimum requirements of the code and red marks the plans notating the code deficiencies to the designer. In some jurisdictions, these redline comments are also communicated in written form using a tool such as, a word document or email.

Most jurisdictions separate the plans received according to size and complexity. The types of plan reviews vary from an over-the-counter review to a full review taking months to complete. Over-the-counter reviews are typically conducted while the customer waits for the results. These reviews are typically for small commercial and residential remodeling projects, where plans may not be required and the review is conducted based on an analysis of the description of work on the application form. The over-the-counter reviews vary by jurisdiction, but can be as high as 30% to 40% of the permit activity. Many of the remaining permits require some form of plans to be submitted in order for a review to take place. Most jurisdictions divide the plan reviews into residential and commercial as a further refinement of their plan review management. The residential plans include one and two family dwellings, whereas the commercial review covers everything else. The division of residential and commercial plans is further supported by the ICC, in that they publish the International Residential Code (IRC) for the one and two family dwellings and the International Building Code (IBC) for the commercial projects. Training and certification programs are customized for each code accordingly and staffing is assigned according to their training and certification.

Typical review times for residential plans range from fourteen to thirty days for the first review, with subsequent correction reviews between seven to twenty days. The typical review process includes reviewing the initial submittal for compliance with the codes and red marking the plans with the noted corrections. The plans are then revised by the designer and resubmitted for additional review. This process may continue several times until the plans are able to be approved according to the jurisdiction. The timeframe for each subsequent review process may range from seven to twenty days, resulting in a total review time of sixty to one hundred and twenty days for a typical single family dwelling. The actual review time may be decreased dramatically if the designer submits “approvable plans”; however, most jurisdictions average over two reviews per plan set. Approvable plans are those plans that were reviewed and checked with the electronic plan review (EPR) process, prior to the first submittal to the jurisdiction.

Commercial review times vary depending on the size and complexity of the project. Most jurisdictions divide the commercial plans into various sizes and offer different review times depending on the size of the project. Project size can be identified by dollar valuation, area in square feet or even cubic feet. Some jurisdictions add an occupancy complexity factor and add more time for the review of projects containing such things as hazardous materials or for high-rise construction, as an example. Moreover, it has been estimated that a single day in the review process can cost a developer between $1,000 and $1,000,000 dollars per day in costs depending on the total construction cost of the project.

Because the review is currently conducted manually and different techniques are utilized by different jurisdictions and reviewers, the consistency of the reviews are always questioned. As such, a need exists for an electronic review of the documents to add a level of consistency and completeness to the review that cannot currently be provided. A need also exists for a system and method for electronically submitting building plans over the Internet for electronic review. Further, a need also exists for providing additional value-added services to planners such as, for example, forwarding building plan information to suppliers and developers to solicit bids, providing highly targeted advertising, providing access to manufacturer specifications, and the like.

### SUMMARY OF THE INVENTION

The invention generally provides an online interface wherein architects, or any other party, may upload (e.g., FTP, HTTP, etc) data files which are indicative of a building plan. Such data files may be generated, for example, by a Computer Aided Design (CAD) application. Uploaded files are checked against a number of preconfigured or newly changed rules representing regulations and building codes for a specific jurisdiction.

Specifically, the invention includes a customizable and configurable (using parameter based settings) workflow system and a flexible Internet based interface that servers to partially or fully replace the traditional manual review process. The system uses automated computer based processes to verify and/or analyze a plan for any reason. In one embodiment, the system analyzes a building plan to determine compliance with the building codes of the jurisdiction. The system includes an intelligent rules based software application that is used to create and interpret rules based on building codes from the ICC or any other codes standard now known or known in the future. When a plan is automatically analyzed, the system updates a digital copy of the plan with identifiers and notations to inform the author of the plan as to where it failed the building code compliance test. The user can select an out-of-compliance indicator and/or message to review a code that was applied as well as details of why an element was out of compliance. The system further provides recommendations for bringing an element into compliance. The system is a scalable solution that can be implemented in phases and configurable for different governing jurisdictions within the United States and/or any other country.

The system further analyzes building plans in light of various opt-in services that the plan author may have enrolled. One such service is a reverse auction, or Dutch auction. According to the embodiment, the system automatically detects building elements (e.g., when it performs the compliance check) and forwards this information to appropriate participating contractors and/or suppliers for bid. In another embodiment, the system uses this information to provide highly targeted advertising and/or specials to the author. For example, if a building includes a fire sprinkler system, then the system may retrieve an advertisement from an installer to be displayed within the system user interface.

### BRIEF DESCRIPTION OF THE DRAWINGS

A more complete understanding of the present invention may be derived by referring to the detailed description and claims when considered in connection with the Figures, wherein like reference numbers refer to similar elements throughout the Figures, and:

FIG. 1 is a block diagram illustrating major system components for performing building code compliance checks on electronic building plans, in accordance with an exemplary embodiment of the present invention;

FIG. 2 is a block diagram illustrating various software modules and data stores of a compliance utility, in accordance with an exemplary embodiment of the present invention; and,

FIG. 3 is flow chart illustrating a high level view of the process of extracting drawing elements for the purpose of determining building code compliance, in accordance with an exemplary embodiment of the present invention; and,

FIG. 4 is flow chart illustrating a detailed view of building plan standards analysis and compliance with building codes of a jurisdiction, in accordance with an exemplary embodiment of the present invention.

### DETAILED DESCRIPTION

The detailed description herein is presented for purposes of illustration only and not of limitation. For example, the steps recited in any of the method or process descriptions may be executed in any order and are not limited to the order presented. For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The invention includes a unique system and method for electronic building plan submission and compliance checking. The system includes a number of computing systems, applications, and components that are used to analyze building plans in light of preconfigured rules. As used herein, “preconfigured” or any similar terms may include establishing the configuration upon implementation of the system, a random configuration, changing the configuration during certain time periods, partial configurations and/or the user, host or any other third party configuring the system at a specific time or during any step in the processes discussed herein. The system further includes systems and databases for storing such rules and for facilitating the provisioning of additional services including, for example, a reverse auction, advertising, special offers, product specifications, product information, price comparisons, and the like.

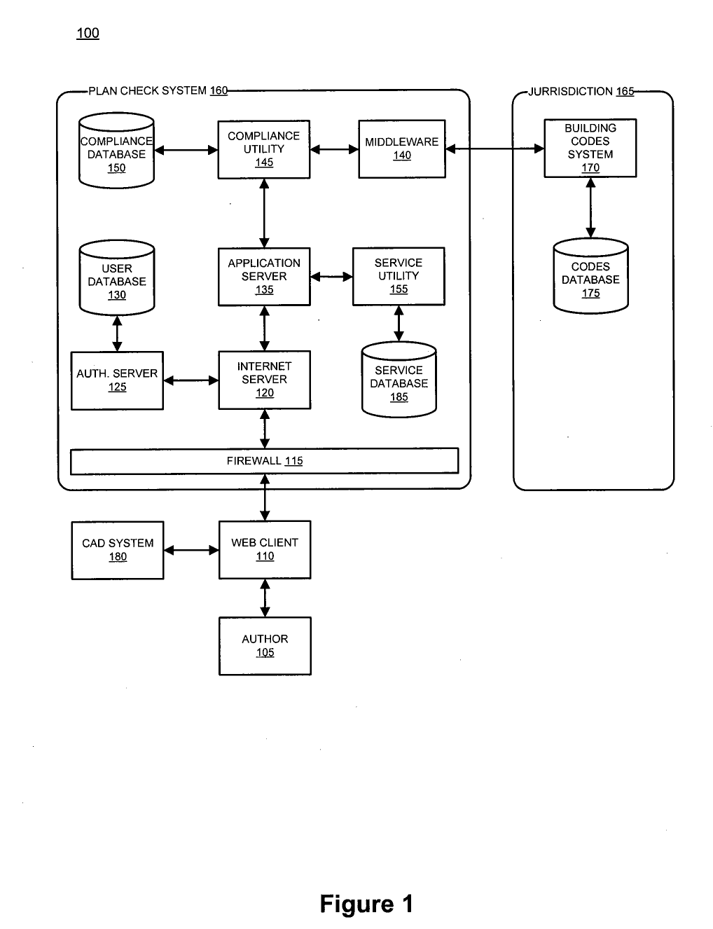

With reference to FIG. 1, in one embodiment, the system includes an author 105 interfacing with a PCS (plan check system) 160 by way of a web client 110. Transmissions between author 105 and Internet server 120 may pass through a firewall 115 to help to ensure the integrity of PCS 160 components. Practitioners will appreciate that the invention may incorporate any number of security schemes or none at all. In one embodiment, Internet server 120 receives data files and page requests from web client 110 and interacts with various other PCS 160 components to perform tasks related to requests from web client 110. Internet server 120 may invoke an authentication server 125 to verify the identity of author 105 and assign specific access rights to author 105 or any other user discussed herein. Authentication database 130 may store information used in the authentication process such as, for example, user identifiers, passwords, access privileges, user preferences, user statistics, and the like. When a request to access PCS 160 is received from Internet server 120, Internet server determines if authentication is required and transmits a prompt to web client 110. Author 105 enters authentication data at web client 110, which transmits the authentication data to Internet server 120. Internet server 120 passes the authentication data to authentication server which queries user database 130 for corresponding credentials. When author 105 is authenticated, author 105 may access compliance utility 145 for the purposes of configuration, reviewing monitoring data, viewing reports, and the like.

When author 105 is granted access to PCS 160, Internet server 120 may invoke an application server 135. Application server 135 invokes compliance utility 145 by passing parameters relating to author 105 selection of an action and/or upload of data from an interface provided at web client 110. According to one embodiment, application server 135 may further invoke a report engine based on data derived from compliance database 150 or any other component of system 100. A report may include, for example, a compliance report based on a building plan compliance analysis.

When invoked by application server 135, compliance utility 145 constructs a query to retrieve codes for the appropriate jurisdiction from compliance database 150. Moreover, compliance utility 145 interacts with middleware 140 in order to retrieve building codes from one or more jurisdictions 165. The codes may be simply downloaded via the Internet, or the system may obtain data feeds from government databases or private services. Practitioners will appreciate that middleware 140 enables communication among disparate systems, thus middleware 140 may not be necessary based on the platforms used in PCS 160 and jurisdiction 165. Moreover, compliance utility 145 communicates directly with any of the systems at jurisdiction 165 by way of web services and/or any other known technology. Practitioners will appreciate that jurisdiction 165 may include any number of computing systems and databases that are used to maintain building code information for the purposes of checking building plans, issuing building permits, performing on-site inspections, and the like. For the purpose of discussion, jurisdiction 165 will be described herein as comprising a building codes system 170 and a codes database 175.

According to one embodiment, PCS 160 includes a service utility 155 for retrieving targeted advertisements, product information, specifications, facilitating auctions, and the like from services database 185. Service utility 155 may interact with compliance utility 145 to retrieve information that is specific to author 105 and building plan elements. In one embodiment, service utility 155 further interacts with authentication server to retrieve information relating to author 105 preferences, demographics, historical data, and the like. Service utility 155 may also analyze author trends to determine the appropriate offers to provide to the author. For example, service utility 155 may determine from previous author submissions that the author often uses certain tile flooring, so service utility 155 may obtain offers related to the specific tiles. Service utility may also analyze trends or obtain historical data related to any entity associated with the author. For example, regardless of the author 105, service utility 155 may determine that ABC Development company (the developer of the project) has submitted plans for different buildings, wherein the plans all include the same type of facet components. The system may then obtain an offer related to a larger quantity of the facet components.

The above information may be combined with information from compliance utility to provide services that are specifically tailored for author 105 relative to a building plan that is provided to PCS 160 for a compliance analysis. The services may also include complementary services or any other type of services which may be beneficial for any person or entity associated with the system or a building plan.

System 100 (or any of the other components described herein) may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: user database 130, compliance database 150, services database 185, codes database 175, and/or like data useful in the operation of system 100.

As will be appreciated by one of ordinary skill in the art, one or more of the components of system 100 may be embodied as a customization of an existing system, an add-on product, upgraded software, a stand alone system (e.g., kiosk), a distributed system, a method, a data processing system, a device for data processing, and/or a computer program product. Accordingly, individual system 100 components may take the form of an entirely software embodiment, an entirely hardware embodiment, or an embodiment combining aspects of both software and hardware. Furthermore, individual system 100 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The invention contemplates uses in association with loyalty, incentive or reward programs, web services, utility computing, pervasive and individualized computing, security and identity solutions, autonomic computing, commodity computing, mobility and wireless solutions, open source, biometrics, grid computing and/or mesh computing.

Author 105 may include one or more of: an individual, group of individuals, business, entity, government organization, builder, architect, developer, contractor, inspector, software and/or hardware that interact with system 100. Author 105 uploads building plan data files for a code compliance analysis. Author 105 may further interact with system 100 to receive compliance reports, product information, advertisements, special offers, specifications, manuals, instructions, and the like. In one embodiment, author 105 may be an architect charged with the responsibility of designing a commercial or residential building or structure. Author 105 may also be, for example, a field inspector who interacts with system 100 to ensure that physical structures are compliant with an approved building plan. As will be described in greater detail herein, author 105 may further be a homeowner, a business owner, construction superintendent, job foreman, or any other entity with an interest in building plan compliance analysis. In one embodiment, author 105 may interact with PCS 160 via an Internet browser at a web client 110.

Web client 110 comprises any hardware and/or software suitably configured to facilitate input, receipt and/or review of information relating building plans or any information discussed herein. Web client 110 includes any device (e.g., personal computer), which communicates (in any manner discussed herein) with PCS 160 via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that web client 110 may or may not be in direct contact with PCS 160. For example, web client 110 may access the services of PCS 160 through another server, which may have a direct or indirect connection to Internet server 120.

As those skilled in the art will appreciate, web client 110 includes an operating system (e.g., Windows NT, 95/98/2000, OS2, UNIX, Linux, Solaris, MacOS, etc.) as well as various conventional support software and drivers typically associated with computers. Web client 110 may include any suitable personal computer, network computer, workstation, minicomputer, mainframe or the like. Web client 110 can be in a home or business environment with access to a network. In an exemplary embodiment, access is through a network or the Internet through a commercially available web-browser software package.

Web client 110 may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Web client 110 may further include a CAD system 180 for designing building plans. Such CAD systems are well known in the art and standards have been developed to help ensure cross-platform compatibility with other design systems; however, this is not always the case. The present invention anticipates that CAD system 180 may be integrated with web client 110, or as a standalone system in the same or different geographic location as web client 110. In one embodiment, PCS 160 interfaces with CAD system 180 to ensure code compliance in real-time (or within a certain time period) as a plan is being developed. For example, when author 105 attempts to place a solid core wood door into a building plan, PCS system 160 may determine that a metal door is required based on the doors proximity to a storage area where flammable materials may be stored. PCS 160 may alert author 105 of the code violation and further recommend an appropriate door.

Firewall 115, as used herein, may comprise any hardware and/or software suitably configured to protect PCS 160 components from users of other networks. Firewall 115 may reside in varying configurations including stateful inspection, proxy based and packet filtering, among others. Firewall 115 may be integrated as software within Internet server 120, any other system components, or may reside within another computing device or may take the form of a standalone hardware component.

Internet server 120 may include any hardware and/or software suitably configured to facilitate communications between web client 110 and one or more PCS 160 components. Further, Internet server 120 may be configured to receive large data files from web client 110 and transmit data to web client 110 within markup language documents. As used herein, “data” may include encompassing information such as commands, queries, files, data for storage, and/or the like in digital or any other form. Internet server 120 may operate as a single entity in a single geographic location or as separate computing components located together or in separate geographic locations.

Internet server 120 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Application server 135 may include any hardware and/or software suitably configured to serve applications and data to a connected web client 110. Like Internet server 120, application server 135 may communicate with any number of other servers, databases and/or components through any means known in the art. Further, application server 135 may serve as a conduit between web client 110 and the various systems and components of the PCS 160. Internet server 120 may interface with application server 135 through any means known in the art including a LAN/WAN, for example. Application server 135 may further invoke Compliance Utility 145 and service utility 155 in response to author 105 requests.

Compliance Utility 145 may include any hardware and/or software suitably configured to receive building plan data files. Compliance utility 145 may also receive web page requests from web client 110 via Internet server 120 and application server 135. Compliance utility 145 is further configured to process requests, construct database queries, execute queries against compliance database 150, and/or exchange data with a jurisdiction 165 via middleware 140. In one embodiment, compliance utility 145 may be configured to interact with other PCS 160 components to perform complex calculations, retrieve additional data, format data into reports, create XML representations of data, construct markup language documents, and/or the like. Moreover, compliance utility 145 may reside as a standalone system or may be incorporated within application server 135 or any other PCS 160 component as program code.

PCS 160 and any number of jurisdictions 160 may be interconnected via middleware 140. Middleware 140 may include any hardware and/or software suitably configured to facilitate communications and/or process transactions between disparate computing systems. Middleware components are commercially available and known in the art. Middleware 140 may be implemented through commercially available hardware and/or software, through custom hardware and/or software components, or through a combination thereof. Middleware 140 may reside in a variety of configurations and may exist as a standalone system or may be a software component residing on the Internet server 120. Middleware 140 may be configured to process transactions between the various components of PCS 160 and any number of internal or external issuer systems 100 for the purposes disclosed herein. In one embodiment, middleware 140 may comprise web services that are invoked to exchange data between the various disclosed systems.

In one embodiment, PCS 160 further includes a report engine (not shown). The report engine includes any hardware and/or software suitably configured to produce reports from information stored in one or more databases. Report engines are commercially available and known in the art. The report engine provides, for example, printed reports, web access to reports, graphs, real-time information, raw data, batch information and/or the like. A report engine may be implemented through commercially available hardware and/or software, through custom hardware and/or software components, or through a combination thereof. Further, a report engine may reside as a standalone system within PCS 160 or as a component of Internet server 120.

Report engine may show information in text, colors, graphic, video or any other form or media. For example, report engine may show a non-compliant component in a different color, or display an advertisement for a vendor which may be able to provide a component in the submitted building plan. In one embodiment, vendors may submit advertisements, product information, product pictures, links to websites, rules (e.g., when to display an ad), qualifications (e.g., only certain types of projects qualify for their services), and the like for storage by the system. In another embodiment, the system searches the Internet and other databases to obtain information on products and services that may be appropriate for certain components of the building plan. The system may also include rules or receive rules from authors about the types of advertisements it will allow to be displayed. The system then analyzes the components of the plan and searches the database of vendor information to determine the appropriate vendor information to display in the report.

In order to control access to application server 135 or any other component of PCS 160, Internet server 120 may invoke an authentication server 125 in response to author 105 submissions of authentication credentials received at Internet server 120. Authentication server 125 may include any hardware and/or software suitably configured to receive authentication credentials, encrypt and decrypt credentials, authenticate credentials, and/or grant access rights according to pre-defined privileges attached to the credentials. Authentication server 125 may grant varying degrees of application and data level access to users based on information stored within user database 130.

User database 130 may include any hardware and/or software suitably configured to facilitate storing identification, user preferences, user rules, user restrictions, authentication credentials, and/or user permissions. Compliance database 150 stores data relating to building codes, CAD elements, and the like. Codes database 175 stores building codes, rules and regulations pertaining to a jurisdiction. One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 100, the data can be stored without regard to a common format. However, in one exemplary embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Referencing the computer networked aspect of an exemplary embodiment of this invention; each participant is equipped with a computing system to facilitate online commerce transactions. The computing units may be connected with each other via a data communication network. The network is a public network and assumed to be insecure and open to eavesdroppers. In the illustrated implementation, the network is embodied as the internet. In this context, the computers may or may not be connected to the internet at all times. For instance, the cardholder computer may employ a modem to occasionally connect to the internet, whereas the card provider computing center might maintain a permanent connection to the internet. It is noted that the network may be implemented as other types of networks, such as an interactive television (ITV) network.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

Frequent reference is made herein to Drawing Web Format (DWF) and DWG files. However, practitioners will appreciate that system 100 may perform the disclosed automated plan checking processes using other file types now known and/or known in the future. One such example is a Building Information Modeling (BIM) file. Current manufactures of software platforms supporting BIM include, for example, ArchiCAD, Catia, Bently, Revit, and Triforma. BIM, and its associated software platform, provides for the creation a three-dimensional model of a building or structure from data generated by a CAD system. This three-dimensional model may be used to reduce “collisions” between various building elements, thus reducing the costs associated with change orders and other construction problems. A BIM virtual model is created through the combination of several CAD drawings that are each created by various construction trades (e.g., mechanical, electrical, plumbing, etc.). The virtual model includes a deep level of detail that was previously difficult to ascertain from CAD drawings alone including, for example, the number of pre-cast floor slabs and the number of hinges on all of the doors that are included in the drawing plan for a school. As such, practitioners will appreciate that PCS 160 processing of BIM files may produce an even greater level reliability and sophistication within the disclosed building code compliance checking.

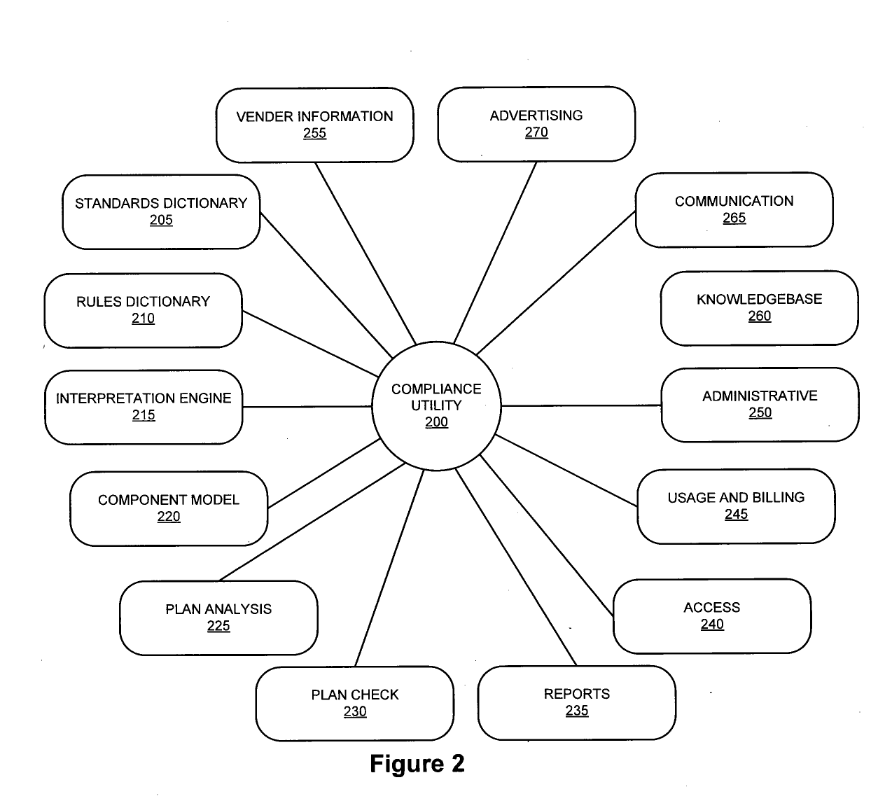

With reference to FIG. 2, an exemplary architecture of PCS 160 enables the various services disclosed herein to be provided by way of an Application Service Provider (ASP) model, wherein author 105 subscribes and is granted access to the various PCS 160 components by way of the Internet. The services enable author 105 to download PCI standards, apply the standards to their version of AutoCad, upload the building plan in DWF, DWG, or BIM format, and receive various reports showing the areas of compliance and non-compliance based on the appropriate jurisdictional building codes. According to one embodiment, the process of reading and writing DWF and DWG files is implemented using a DWF Software Development Kit provided by AutoDesk. However, practitioners will appreciate that other file formats may be contemplated in terms of the compliance checking processes disclosed herein.

While illustrated as a single PCS 160 component, compliance utility 145 may comprise any number of functions, code modules, applications, web services, databases, and the like. In one embodiment, service utility 155 is a module residing with compliance utility 145. To provide a better understanding of the various functionalities provided by system 100, compliance utility 145 will be described in terms of specific libraries, code modules, and utilities.

Compliance utility 200 includes a Plan Submittal Standards Dictionary 205 which maintains standardized naming conventions. Such standardized naming conventions may be defined and published by the administrators of system 100 or any other entity. The standardized naming conventions may further be derived from existing standards defined by organizations such as, for example, the National CAD Standards. Standardized layer names, drawing element names, as well as any other drawing elements and their interrelationships are stored in compliance database 150. An administrator, or any other designated party, may interact with PCS 160 to maintain this information and subscribers (e.g., author 105) may download information from the Plan Submittal Standards Dictionary 205 from an Internet server into CAD system 180 such that building plans generated within CAD system 180 will adhere to the standardized naming conventions.

According to one embodiment, names may be standardized for construction plans by designating the first character to define a plan type such as, for example using an “R” for residential and “C” for commercial. The next two characters may be reserved for identifying a drawing type and the next three characters may identify a floor number. Finally, a three digit sequence number may be appended to the end of the name. Each field may be separated by a hyphen. As such, “C-EL-001-001” may be a standard filename, for example, for a commercial electrical drawing plan for the first floor of a building.

Building plan layer names may follow similar naming standards, beginning with a two-character code such as, for example, “AR” for architecture, “EL” for electrical, “PL” for plumbing, and the like. Moreover, drawing element names may be similarly standardized. The naming standards are stored in compliance database 150 for each governing jurisdiction.

A Building Codes Rules Dictionary 210 maintains building codes as defined by the International Code Council (“ICC”) with local variations and related information. The Building Codes Rules Dictionary 210 may be stored in compliance database 150 as a hierarchy of codes along with semantics on how they should be applied to a building plan. Codes may also be stored according to a relations model, wherein each code may have one-to-many relationships with other codes, elements, and components. Each rule may be flagged as to whether or not the rule is applicable within a particular governing jurisdiction. According to one embodiment, a user interface is provided to enable a PCS administrator to add and update this information on an ongoing basis. Author 105 is provided with an interface at web client 110 whereby access to this information is provided. The interface enables author 105 to search the Building Codes Rules Dictionary 210 by keywords, codes, or by any other appropriate method. The interface may further provide, for example, tips, hints, Frequently Asked Questions (“FAQ”), etc., which are drawn from a knowledgebase. In one embodiment, such a knowledgebase may be updated and/or expanded as plans are checked.

A Building Codes Interpretation engine 215 includes a set of objects and methods that are used to interpret information in the Building Codes Rules Dictionary 210 for application to a building plan. Each object comprises multiple encapsulated methods that have the ability to apply a set of building codes to a building plan. For example, egress requirements may have multiple clauses based on occupancy, travel distance, impediments, floor etc.

A Building Plan Component Model 220 module extracts building plan components, elements and their relationships, and any other information from an uploaded DWG, DWF, or other digital building plan file format. The Building Plan Component Model 220 module stores this extracted plan information in compliance database 150 as a relational object model for interpretation by one or more compliance utility 200 modules. In one embodiment, extracted plan information is stored with system-generated prefixes, which identifies the drawing author 105 as well as the identity of a set of plans that the extracted plan information belongs to. Each drawing layer may further be stored with the appropriate information so that it can be uniquely identified back to a specific drawing.

A Building Plan Analysis module 225 reads the plan information stored within the Building Plan Component Model 220 and compares it to, for example, the PCI plan submittal standards and the Plan Submittal Standards Dictionary 205 with the objective of identifying missing components and/or non-standard usage. The Building Plan Analysis module 225 further verifies the completeness of a building plan. In one embodiment, missing and/or non-standard components may be identified within a report. Practitioners will appreciate that a report may be provided to author 105 by any means known in the art including, for example, by email, web page interface, facsimile, cell phone, personal digital assistant, and the like. Such a report specifies missing and/or non-standard components that need to be modified and/or included in the PCI plan submittal standards and the Plan Submittal Standards Dictionary 205.

Moreover, the Building Plan Analysis module 225 may create a new DWF file, for example, that includes notations in red (or any user defined color) identifying areas where non-standard usage, as compared to the published standards, were located. The notations may direct the author's attention to areas of a building plan that require modification such that the building plan may be re-submitted for a second check. In another embodiment, Building Plan Analysis module 225 may proceed with an analysis even when standards have not been followed. Accordingly, only a portion of the building plan that incorporates PCS 160 standards will be checked.

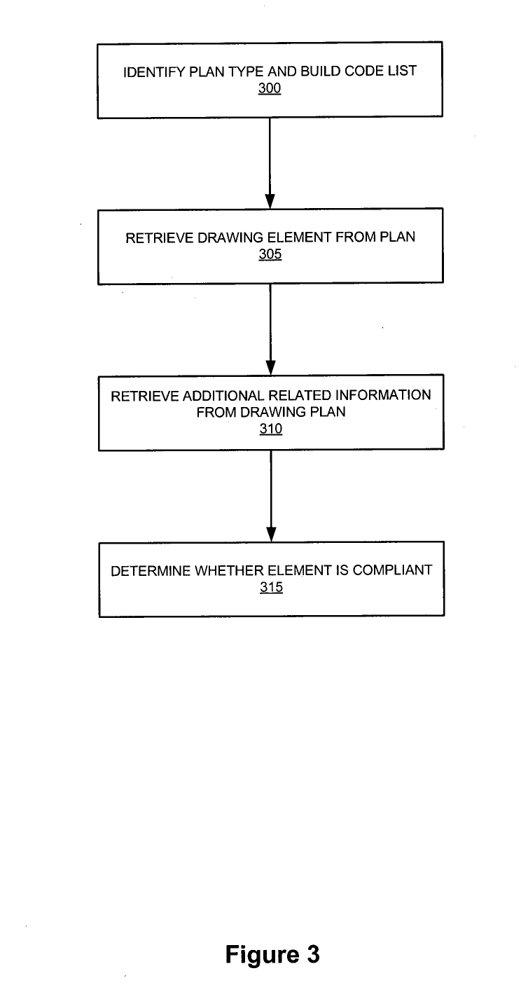

A PlanCheck module 230 is configured to read building plan information stored in the Building Plan Component Model 220 and invoke the Building Codes Interpretation Engine 215 to apply the appropriate building codes and the rules from the Building Codes Rules Dictionary 210. The PlanCheck module 230 may further determine whether a building plan complies with the various applicable codes and rules. With reference to FIG. 3, the PlanCheck module 230 identifies the plan type (e.g., residential or commercial) and constructs a list of all the codes that should be checked for the plan type (step 300). The list of appropriate codes for the plan type may be retrieved from the Building Codes Rules Dictionary 210.

For each code rule that needs to be applied to a building plan, PlanCheck module 230 retrieves the relevant drawing elements for each layer of the building plan (step 305) from the Building Plan Component Model 220 to create an element list. For example, if a code to be checked relates to an egress requirement, then PlanCheck module 230 retrieves the exit doors from the building plan. The PlanCheck module 230 also retrieves all other information related to each drawing element, building codes that should be applied, and rules as to how the building codes should be applied (step 310). The PlanCheck module 230 uses the element list and the information related to each drawing element to create a list of rules to apply to the building plan and builds a list of elements that will be required for each rule in the list. The enables PCS 160 to construct a complete repository of all of the information needed to ensure that the information is complete prior to invoking the plan check process. According to one embodiment, PlanCheck module 230 includes a verification process to ensure that each element in the element list meets the appropriate compliance requirement. Finally, the PlanCheck module 230 invokes the Building Codes Interpretation Engine 215 to apply each rule in the list to determine whether or not each building plan component passes the building code check (step 315.

According to one embodiment, the output of the PlanCheck module 230 is by way of a compliance report. The compliance report may identify each component that was checked along with identifying any components were found to be non-compliant. The compliance report may further provide helpful hints as to how to correct the non-compliant components and may be provide to author 105 by any means known in the art such as, for example, a web page interface that enables the report to be saved and/or printed. When a building plan is found to be compliant with the appropriate codes, then PlanCheck module 230 may provide author 105 with a “Certificate of Compliance” based on agreements with a governing jurisdiction, caveats and disclosures. Moreover, the PlanCheck module 230 may create an updated DWF file with notations identified by a specified color, symbol, or other indicator identifying areas of non-compliance. The notated DWF file enables author 105 to appropriately modify and re-submit the building plan. Practitioners will appreciate that PlanCheck module 230 may create an updated building plan file of any type and format currently known or known in the future.

As discussed herein, system 100 may provide any number of reports relating to, for example, a set of building codes applied to a building plan, how the codes are interpreted and applied, relationships of the various building plan components (as stored in the Building Plan Component Model 220), compliance and non-compliance of building plans, helpful hints to assist in remedying non-compliant building plans, and the like. A Reports Module 235 may be configured to generate and provide such reports to author 105, an administrator, and/or any other designated party. The Reports Module 235 may further generate reports, provide links, or provide other information relating to product specifications, assembly instructions, vender information, manufacturer information, advertising, special offers, project bidding, supplier bidding, and the like. As discussed above, this information may be obtained from vendors and stored in a database for retrieval by the system based on certain rules, and/or the Internet may be searched to obtain certain information.

An Access Module 240 maintains and governs access to software and communications relating to compliance utility 200. The Access Module 240 may, for example, enable various levels of users to login and access various functionality provided by compliance utility 200. In one embodiment, the Access Module 240 provides access to various functions of compliance utility 200 based on the author's 105 subscription level. Author 105 may further maintain a subscriber profile, upload a building plan, receive an offer, opt-in or opt-out of various services, receive compliance reports, and the like. The Access Module 240 may further manage communications between author 105 and the PCS 160.

In one embodiment, a Usage and Billing module 245 may manage author 105 usage based on a fee-for-service model. Fees may be determined by, for example, the number of plans checked, size of the building, complete check, partial check (based on the modules subscribed to), opt-in services, and the like. The Usage and Billing module 245 may track author 105 usage and generate periodic invoices for payment of used services. In another embodiment, the Usage and Billing module 245 may require pre-payment for specific services, wherein author 105 is prevented from exceeding the terms of the pre-paid services.

An Administrative Module 250 provides an interface to an administrator, or any other designated entity, to manage various aspects of a PCS 160. An administrator may interact with the Administrative Module 250 to, for example, manage PCS 160, setup users, manage profiles, maintain usage and billing information, establish services, manage databases, and the like. The system may also provide a status check component, so the author can check the status of the building plan review at any time.

A Vendor Information Module 255 maintains information relating to vendors and/or suppliers. Such vendors may participate in system 100 by placing ads within various interfaces and/or email messages that are generated to communicate with subscribers. As will be described in greater detail herein, advertisements, offers, product information, service descriptions, and the like may be targeted to subscribers based on information obtained from uploaded building plans. For example, if a plan includes stucco walls, the Vendor Information Module 255 may retrieve advertisements and/or offers from services database 185 relating specifically to stucco suppliers and installers. The Vendor Information Module 255 may further provide suggestions and contact information to make the plans more environmentally friendly, save money, reduce energy consumption, and/or any other type of improvement. The Vendor Information Module 255 may also notify any person or entity (architects, suppliers, etc), via any communication device or method discussed herein, with status, approvals, changes or other information.

Compliance utility 200 may further include a Knowledgebase Module 260 for maintaining a collection of information useful for providing tips, answers to frequently asked questions, recommendations, and the like. A Communications Module 265 is configured to manage communications between any of the various parties disclosed herein for any of the purposes disclosed herein. An Advertising Module 270 manages the various advertising and offer related functions as disclosed herein.

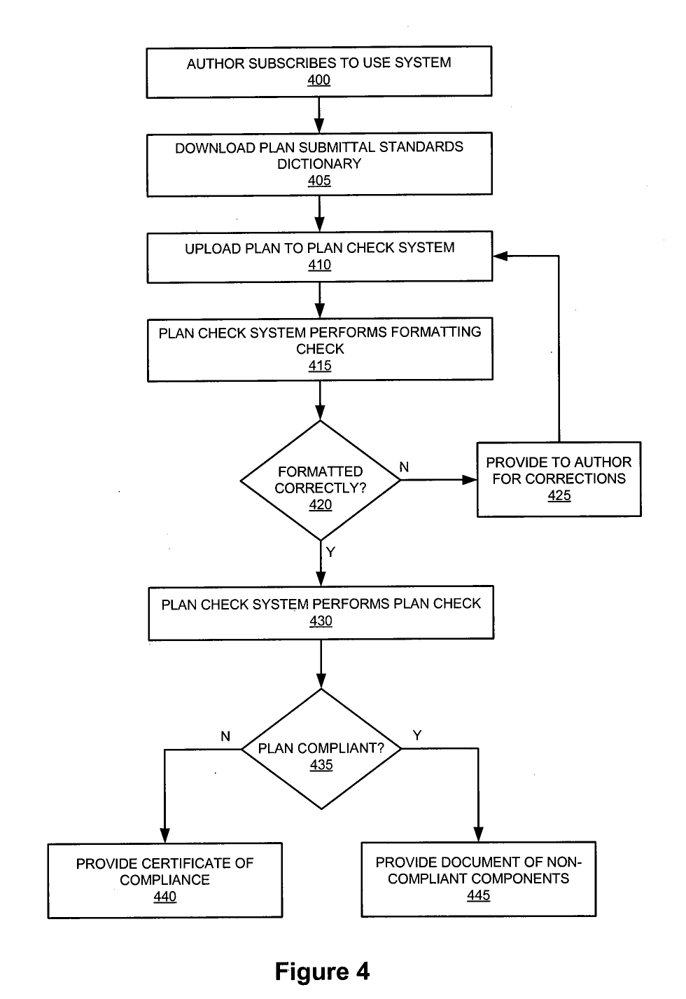

With reference to FIG. 4, an author may subscribe (step 400) to use the services of PCS 160 through, for example, completion of a registration and payment web page. Author 105 subscribes to obtain general access to PCS 160 and to further select the modules that author 105 would like to subscribe to. On acceptance of a subscription, PCS 160 provide access in accordance with the appropriate access levels. Author 105 may receive a PCS 160 web site URL, an access identifier, and a password by way of email or any other means known in the art. According to one embodiment, author 105 may be required to agree to certain terms and conditions and/or a service level agreement during the subscribing process or on the first login.

If a logged in author 105 is a first-time user of PCS 160 or if information has changed within the Plan Submittal Standards Dictionary, then PCS 160 enables web client 110 to download the appropriate Plan Submittal Standards Dictionary (step 405). In one embodiment, author 105 may further download software to apply the standards to CAD system 180. The downloaded Plan Submittal Standards Dictionary is installed on web client 110 and executed in order to automatically load the standards.

Author 105 may upload a building plan to PCS 160 using a menu option or link within an interface provided at web client 110 (step 410). Author 105 may be prompted to select a file location for the building plan, and when an appropriate file is selected, web client 110 uploads the selected file to Internet server 120. Internet server 120 transmits a confirmation to web client 110 when the building plan file has been successfully received. Application server 135 automatically invokes compliance utility 145 to perform a formatting analysis on the uploaded building plan (step 415). Formatting analysis examines the uploaded building plan to ensure that it has been compiled in accordance with the defined naming standards. Compliance utility 145 creates the Building Plan Component Model for the building plan and executes the Building Plan Analysis module. If during the formatting analysis, the Plan Analysis module identifies any non-standard and/or unrecognized usage (step 420), then PCS 160 provides author 105 with a notification relating to non-standard or unrecognized usage. In one embodiment, author 105 may receive more detailed information regarding the non-standard and/or unrecognized usage by accessing PCS 160 and selecting an appropriate menu option. Moreover, PCS 160 may generate and send an email message to author 105 detailing the non-standard and/or unrecognized usage. In yet another embodiment, an email message my include limited information, providing a direct link to PCS 160 where a more detailed information relating to non-standard and/or unrecognized usage may be reviewed. PCS 160 may further allow web client 110 to download an updated building plan file with appropriate markings to show non-standard usage and provide any other information as disclosed herein (step 425). In one embodiment, PCS 160 may perform a formatting analysis on a portion of a building plan where PPCPS standard codes have been implemented.

In one embodiment, author 105 is prevented from running the Plan Check Module until all non-standard usage is fixed and the updated building plan is uploaded to PCS 160 (step 410). Specifically, the building plan may be updated by author 105 using CAD system 180 and then uploaded to PCS 160 for a second analysis as described above.

When a building plan passes the analysis check and is ready to be automatically reviewed by the PCS 160 for compliance, author 105 logs in and uses a menu option, for example, to access the appropriate interface. Compliance utility 200 invokes Plan Check Module 230 to begin the compliance check (step 430). Plan Check Module 230 reads the names identifying the various components of the building plan. Accordingly, a code corresponding to the component identifier is retrieved from compliance database 150 for the appropriate jurisdiction. The component from the building plan is compared with the corresponding code to determine whether or not the component is compliant. In one embodiment, the compliance check runs in the background and author 105 is notified by email with relevant information and/or links to a web page detailing the results of the plan check. For example, author 105 may review detailed plan check information by logging to PCS 160 and selecting an appropriate menu option. An updated DWF may also be provided to web client 110 with appropriate markings to show non-compliance.

When a building plan has been successfully processed and approved by PCS 160 (step 435), then author 105 is provided an interface from which to print a certificate of compliance (step 440). In one embodiment, the certificate of compliance includes disclaimers and disclosures, such that the owners of PCS 160 are legally protected in the case of program and/or human error. In one embodiment, author 105 may further print or retrieve a Portable Document Format (PDF) report of all the building codes that were applied, code identifiers (e.g., 100.8 of ICC), actual plan parameters (e.g., required distance by code is 20 ft., the plan had 18 ft.), and the like. PCS 160 may further maintain a history of the type of building plan submitted by author 105 as well as any other information. This information may be desirable for diagnosing program errors, performing audits, and for the targeting of advertisements and offers based on a transactional history.

According to one embodiment, PCS 160 may enable web client 110 to download a variant of compliance utility 145. The variant may be in the form of a software module such as, for example, a Dynamic Link Library (DLL) that may be accessed by CAD system 180. In one embodiment, CAD system 180 may issue a call to the variant when author 105 begins drafting a building plan, such that the variant may perform compliance checking in real-time as the building plan is being constructed. The variant may retrieve the appropriate jurisdictional codes from compliance database 150 by way of the Internet. In another embodiment, the variant may accesses codes that are downloaded and stored locally, in advance of the building plan drafting process. In yet another embodiment, the full functionality of compliance utility 145 remains at PCS 160, however, a code module that is used to access various functions of the compliance utility 145 is stored at CAD system 180. In either case, author 105 may be alerted when, for example, adding a 2×4 framed wall where a load-bearing wall is required according to a building code.

A building plan may further be rendered within a web page, which author 105 may access to view via web client 110. During the plan check process, compliance utility 145 may retrieve hyperlinks corresponding to various building plan elements. Such hyperlinks may lead to information stored either internally, externally, or a combination thereof. For example, when compliance utility 145 detects a window from an uploaded building plan file, compliance utility 145 may search for information relating to energy efficient double panned windows. If such information is located, then compliance utility 145 may add a hyperlink, thereby linking the window element to information about double panned windows. Author 105 may subsequently view the building plan at web client 110 and mouse click on a hyperlinked window element to view related information.

As used herein, internal users may include any entity that is authorized to interact with PCS 160 to, for example, maintain hardware, maintain software, perform system testing, define naming conventions, download building code information from various jurisdictions, and the like. Internal users may include system administrators, database administrators, programmers, software testers, system managers, customer service representatives, or any other designated party.

The following provides exemplary steps internal users follow to setup the system. Internal users may define and manage naming standards and create the Plan Submittals Standards Dictionary. Practitioners will appreciate that defining and managing such information would likely be an ongoing process as it will be dependent upon jurisdictions and changes to CAD software systems. To ensure the on-going integrity of data used to determine building code compliance, internal users may regularly review International Code Council (ICC) manuals and enter new and/or changed data into the Building Codes Rules Dictionary. This will also be an ongoing process to keep the information current for each governing jurisdiction.

In one embodiment, internal users may be responsible for the setup of subscribers and other maintenance and support related activities. However, practitioners will appreciate that such activities may be performed by system 100 components, or by any combination of internal users, hardware systems, and software systems.

During both the formatting analysis (step 415) and plan check process (step 430) PCS 160 extracts information relative to each element of a building plan. Because elements of a building plan are named according to the defined standards of PCS 160, each element can be uniquely identified. Such identification of building plan elements enables PCS 160 to provide a number of services that may serve the interests of author 105, product vendors, product manufacturers, service providers, and the like. PCS 160 may enable authors 105 to partially or fully opt-in and opt-out of participation in such services. In one embodiment, authors 105 who agree to participate is one or more provided service may receive subscription discounts, free plan check services, reward points that may be redeemed for goods and services, discounts, free access to product specifications, consultation services, participation in a barter exchange program, and the like.

In one embodiment, information extracted from a building plan is used to create a relevant message within an email notification, which may include, for example, advertisements from vendors offering supplies and services, special offers, links to vender web sites, links to government web sites, and the like. Such advertisements may further be presented within a web interface, for example, while author 105 is uploading a building file or waiting for compliance check results. Practitioners will appreciate that a number of advertising revenue models may be applied by PCS 160 in order to receive payment for ads that are displayed. For example, an advertiser may be billed on a periodic basis based on how many times the ad was clicked during the billing period. Advertisements and offers may be provided with a PCS 160 interface as a link, banner ad, and the like.

Manufacturers, vendors, and service providers may be provided with interfaces that enable them to configure when and how they would like their ad and/or offer data to be presented. For example, a flooring contractor may define rules such that only authors 105 of building plans for construction projects occurring in metropolitan Phoenix area are to receive a special discount offer. Other rules may include, for example, project type, project start date, projects end date, the identity of the general contractor, identity of the architect, specified building materials, estimated project cost, and the like. Moreover, ads and offers may be customized in that the identity of the author 105 is known. For example, if the author is John Smith and John Smith's building plan meets the defined rules for a special offer, an offer may be compiled in real-time. Such an offer may be presented to author 105 and read, “John Smith, Phoenix Flooring has noticed that you are planning a commercial project that requires approximately 4,300 square feet of granite tile flooring. We are in a position to offer you a significant discount if you contact us today.”

Manufacturers, vendors, and service providers may further elect to be notified when a building plan meeting defined notification criteria is received by PCS 160. Such notification may be by any means known in the art including, for example, web page, email, text message, page, phone call, facsimile, and the like. Author 105 may restrict certain notifications by partially or fully opting-out of the service. Those manufactures, vendors, and service providers who choose to receive building plan notifications may interact with PCS 160 to define, for example, what types of projects they are interested in (e.g., commercial or residential), the value of a project, construction materials, location, construction start date, construction end date, and the like. During a building plan analysis, compliance utility 145 extracts component data from the building plan such that it is specifically identified in accordance with the naming standards. Therefore, when compliance utility identifies, for example, metal beams in the building plan, compliance utility may invoke service utility 155 to retrieve supplier of steel products. An analysis is performed to determine whether the project matches the supplier's defined notification criteria. If the project matches the supplier's notification criteria, then PCS 160 generates a notification and provides it to the supplier. In one embodiment, notification may include general information about the building plan such as, for example, the building type, estimated cost, materials list, volume of material required, contact phone number, contact email address, and etc. In another embodiment, the notification may contain a reference or link to a web page where the supplier may view the building plan along with any other pertinent information.

Author 105 may opt-in to participate in a reverse auction, wherein interested manufacturers, suppliers, and service providers may place bids on upcoming projects based on information extracted from a building plan. In one embodiment, author 105 may configure the terms of one or more reverse auctions after a building plan has been uploaded for analysis by selecting which building plan elements should be presented for auction, defining a maximum bid amount, defining a bid open and close date, and the like. Author 105 may further elect to exclude certain manufacturers, suppliers, and service providers from participating in one or more auctions. In one embodiment, author 105 may define one or more manufacturers, suppliers, and service providers that author 105 would be willing to accept a higher bid for. For example, cost is often not the only consideration when selecting a contractor. Further considerations may include licensing information, Better Business Berea (BBB) information, length of time in business, size of the contractor, types of projects that the contractor has previously completed, financial health of the contractor, credit rating, and the like.

Other third-parties may interact with PCS 160, for example, to provide free and/or discounted instructions, specifications, manuals, and any other information that might be relevant and helpful to author's 105 building plans. For example, as a means to attract customers, a manufacturer of lighting fixtures may offer free schematics, specifications, and installation manuals to authors 105 submitting building plans that call for overhead lighting fixtures. Availability of this information may be brought to the attention of author 105 in the form of links within a web page interface, email notifications, etc. Author 105 may be compelled to view, for example, a specification for energy saving fluorescent lighting. Based on this information, author 105 may follow-up with the manufacturer, which may lead to a mutually beneficial agreement.

In one embodiment, PCS 160 provides an interface whereby field inspectors equipped with a wireless computing device, for example, may retrieve information relating to building plans that were previously checked and certified to be compliant. Such information may be useful, for example, for determining when a questionable building component is compliant with building codes for a relevant jurisdiction.

In another embodiment, PCS 160 stores building plans along with histories regarding previous checks performed on the building plans. Accordingly PCS 160 includes an interface, wherein users may access and view such information when a building plan is compliant and has been approved. This may further be useful in performing audits to ensure that PCS 160 if operating correctly.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

We claim:

1. A computerized method for analyzing a building plan for compliance with building codes, said method comprising:
receiving a plan file from a user;
performing a formatting analysis to determine when said plan file is sufficiently formatted;
extracting component data from said plan file;
retrieving offer data based on said component data;
formatting and presenting said offer data to at least one of said user and a third party;
performing a compliance analysis, wherein said compliance analysis determines when said plan file is sufficiently compliant with said building codes;
providing said user with a certificate of compliance when said plan file is compliant with said building codes.

2. The method of claim 1, further comprising causing a web client to download a plan submittal standards dictionary.

3. The method of claim 1, further comprising providing said user with a report detailing errors detected in said formatting analysis.

4. The method of claim 1, wherein said plan file is at least one of: a Drawing Web Format (DWF) file, a DWG file, and a Building Information Model (BIM).

5. The method of claim 1, wherein said formatting analysis determines whether said component data is consistent with predefined formatting rules.

6. The method of claim 1, further comprising providing said user with an updated plan file when said plan file is not correctly formatted, wherein said updated plan file includes notations relating to at least one of: non-standard and unrecognized usage.

7. The method of claim 1, wherein said step of retrieving offer data based on said component data further comprises determining whether said plan file includes a defined element.

8. The method of claim 1, further comprising retrieving said building codes from an appropriate jurisdiction.

9. The method of claim 1, wherein said step of performing a compliance analysis further comprises retrieving a compliance rule corresponding with an element of said component data.

10. The method of claim 1, further comprising providing said user with an instruction relating to how to correct a non-compliant plan file.

11. The method of claim 1, further comprising:
identifying a vendor corresponding to said component data, wherein said vendor includes at least one of a manufacturer, supplier, and service provider;
inviting said at least one of a manufacturer, supplier, and service provider to bid to provide an item based on said component data;
accepting a bid from said vendor; and,
determining a winning bid.

12. The method of claim 1, further comprising providing said user with a view of said building plan within a web page, wherein said view includes a link to a corresponding at least one of: product information, service information, specification, instruction, and comparison.

13. The method of claim 1, further comprising providing said user with a report listing at least one of: building codes that were applied, code identifiers, and actual plan parameters.

14. The method of claim 1, wherein said step of retrieving offer data based on said component data further comprises:
evaluating at least one of: project type, project start date, project end date, an identity of a general contractor, identity of an architect, specified building materials, and estimated project cost relating to said plan file;
retrieving an offer rule corresponding to a provider of said offer data; and,
determining whether said evaluation meets said offer rule.

15. A computer readable medium which includes instructions for analyzing a building plan for compliance with building codes, said instructions comprising:
receiving a plan file from a user;
performing a formatting analysis to determine when said plan file is sufficiently formatted;
extracting component data from said plan file;
retrieving offer data based on said component data;
formatting and presenting said offer data to at least one of said user and a third party;
performing a compliance analysis, wherein said compliance analysis determines when said plan file is sufficiently compliant with said building codes;
providing said user with a certificate of compliance when said plan file is compliant with said building codes.
